(19) United States
(12) Patent Application Publication
(10) Pub. No.: US 2007/0044776 A1
(43) Pub. Date: Mar. 1, 2007

(54) Variable speed supercharger

(75) Inventors: Mircea Gradu, Massillon, OH (US); Richard Domin, Navarre, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company

(21) Appl. No.: 11/214,435

(22) Filed: Aug. 29, 2005

(51) Int. Cl. F02B 33/00

(52) U.S. Cl. 123/559.3; 123/559.1

(57) ABSTRACT

A supercharger for an internal combustion engine includes a housing in which an impeller rotates to pressurize the intake manifold of the engine. The impeller is connected to the crankshaft of the engine through a magnetic clutch which enables the impeller to remain at rest or to rotate at a speed that is independent of the speed of the crankshaft and is under control of an engine management system or the operator of the engine.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates in general to superchargers for internal combustion engines and more particularly to a supercharger that operates at speeds independent of engine speed.

Spark ignition engines have provided the main source for power for automotive equipment for years, and this holds particularly true for automobiles and light trucks. However, with the rise in the cost of fuel and concerns for the environment, automotive manufacturers have reduced the displacements of the spark ignition engines used to power their vehicles, yet have sought to maintain near equivalent power. The supercharger represents one device for achieving that end.

By forcing a mixture of air and fuel into the cylinders of a spark ignition engine, a supercharger will enable the engine to develop considerably more power than a conventionally aspirated engine of equivalent displacement. But under most driving conditions an automobile equipped with an engine of relatively small displacement does not require the additional power that a supercharger provides. Nevertheless, the engine continues to power the supercharger and that wastes energy and reduces the efficiency of the engine.

Apart from that, most superchargers at low engine speeds do not provide a significant boost in power where larger demands are suddenly imposed on the engine, such as when the engine is called upon to rapidly accelerate a vehicle. This certainly holds true for those superchargers, that produce manifold pressures that vary nonlinearly with engine speed and are relatively low at low engine speeds. With this type of supercharger, manifold pressure rises sharply with speed. Ideally, it should remain generally constant.

Moreover, if an engine equipped with a supercharger operates at high speed with the supercharger providing an extra measure of power, and then its throttle is suddenly closed, the supercharger will continue to boost manifold pressure even though additional power is not necessary. This has led to the installation of relief valves in supercharged engines

### BRIEF DESCRIPTION OF THE SEVERAL VIEWS OF THE DRAWINGS

FIG. 1 a perspective view of a supercharger constructed in accordance with and embodying the present invention;

FIG. 2 is a longitudinal sectional view of the supercharger taken along line 2-2 of FIG. 1;

FIG. 3 is an end view of the supercharger; and

FIG. 4 is an enlarged sectional view of the clutch for the supercharger.

### DETAILED DESCRIPTION OF THE PREFERRED EMBODIMENT

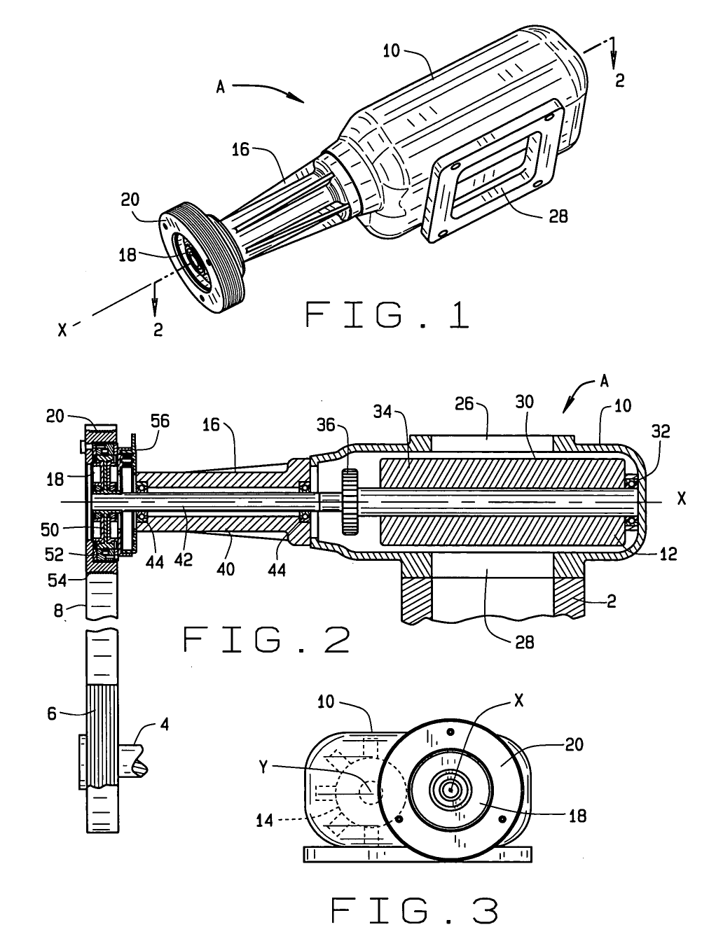

Referring now to the drawings, a supercharger A (FIGS. 1 & 2) forces a combustible mixture of air and fuel, or for that matter simply air, through a manifold 2 of an internal combustion engine. That manifold 2 leads to intake valves at the ends of cylinders in which pistons reciprocate. Those pistons, operating through connecting rods, rotate a crankshaft 4 which in turn powers the supercharger A, there being a direct mechanical connection between the crankshaft 4 and the supercharger A. That connection takes the form of a drive pulley 6 fitted to the crankshaft 4 and an endless belt 8 that passes over the pulley 6.

The supercharger A includes (FIGS. 2 & 3) a primary housing 10 that is mounted on the manifold 2 and two impellers 12 and 14 that rotate within the housing 10 about parallel axes X and Y. In addition, the supercharger A has an impeller drive 16 through which power is transmitted from a magnetic particle clutch 18, which also forms part of the supercharger A. Finally, the supercharger A includes a driven pulley 20 over which the belt 8 passes. The pulley 20 delivers power from the belt 8 to the clutch 18 which in turn transmits it to the impeller drive 16 and thence to the impellers 12 and 14. The impeller drive 16, the clutch 18, and the drive pulley 20 are all organized about the axis X and indeed rotate about the axis X.

The primary housing 10 includes (FIG. 2) an inlet 26 and an outlet 28, the latter of which opens into the manifold 2. The housing 10 encloses a chamber 30 in which the two impellers 12 and 14 rotate and further contains bearings 32 that support the rotors 12 and 14 so that they revolve about their respective axes X and Y.

Each impeller 12 and 14 has (FIGS. 2 & 3) vanes 34 and a gear 36 at one end. The gears 36 of the two impellers 12 and 14 mesh and are of equal size, so that the two impellers 12 and 14 rotate at the same angular velocity, but in opposite directions.

The arrangement is such that the vanes 34 on the counterrotating impellers 12 and 14 draw air from the inlet 26 and force it out of the outlet 28 at a higher pressure, so that the air within the manifold 2 is pressurized.

The impeller drive 16 (FIG. 2) includes a support housing 40 and an input shaft 42 which rotates in the housing 40 about the axis X on bearings 44. The support housing 40 is secured firmly to the primary housing 10 and in effect forms part of the primary housing 10. The shaft 42 at one end is coupled to the impeller 12, so that it rotates the impeller 12 which, in turn, rotates the impeller 14. The other end of the shaft 42 projects out of the support housing 40 where it is coupled to the clutch 18.

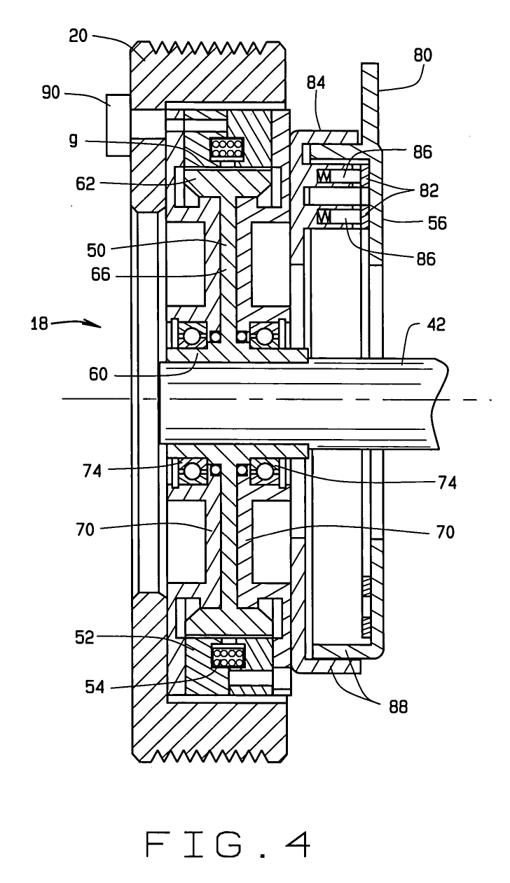

The magnetic particle clutch 18 (FIG. 4) includes an inner clutch element 50 and an outer clutch element 52 which are organized concentrically about the axis X. In addition, it has an electromagnet 54 that is carried by the outer clutch element 52 and a connector assembly 56 for connecting the electromagnet 54 to a source of electrical energy.

The inner clutch element 50 is coupled to and rotates with the input shaft 42 of the impeller drive 16. To this end, it has a sleeve 60 that fits over the shaft 42, to which it is coupled with a spline or key, so that the two will always rotate at the same angular velocity. The inner element 50 also has a rim 52 provided with a cylindrical surface that is presented outwardly away from the axis X and forms the periphery of the inner element 50. The sleeve 60 and the rim 52 are joined together by a web 66 that is considerably narrower than both.

The outer clutch element 52 encloses the inner clutch element 50, yet is capable of rotating relative to the inner clutch element 50. To this end, it has two sections 70 which fit along the sides of the web 66 for the inner element 50, and they provide a hub 72 which encircles the sleeve 60 of the inner element 50. Between the hub 72 and sleeve 60 are antifriction bearings 74 that enable the outer element 52 to rotate relative to the inner element 50, with the axis X being the axis of rotation. The two bearings 74 are isolated from exterior contaminants by seals that likewise fit between the sleeve 60 and hub 72. The sections 70 of the outer element 52 also extend over the rim 62 of the inner element 50 where they provide a cylindrical surface that is presented inwardly toward the axis X and toward the cylindrical surface on the rim 62 of the inner element 50. Between the two cylindrical surfaces is a gap g of uniform thickness. It contains magnetic particles, that is to say, particles that are capable of being magnetized in the magnetic field. When magnetized, the particles in the gap g are capable of transferring torque from the outer clutch element 52 to the inner clutch element 50. The field is produced by the electromagnet 54, which is captured in the outer element 52 slightly outwardly from its cylindrical interior surface. Thus, the magnetic particles constitute a torque-transfer substance.

The connector assembly 56 lies between the housing 40 and the two elements 50 and 52 of the clutch 35. It includes a stationary connector 80 that is attached to the end of the housing 40 and is formed from a dielectric substance. The connector 80 carries inner and outer slip rings 82, which are formed from an electrically conductive material. In addition, the connector assembly 56 includes a rotating connector 84 that is likewise formed from a dielectric substance. It carries inner and outer brushes 86 which are formed from an electrically conductive material and are biased by springs against the inner and outer slip rings 82, respectively, on the stationary connector 80. Outwardly, from the slip rings 82 and brushes 86, the two connectors 80 and 84 have circumferential ribs 88 that create a labyrinth for excluding contaminants from the slip rings 82 and brushes 86.

The electromagnet 54 is, in effect, an annular coil having two leads, one attached to the inner brush 86 and the other to the outer brush 86. The slip rings 82 of the stationary connector 80 are connected across a source of electrical energy, such as the storage battery of an automotive vehicle, there being a control forming part of an engine management system interposed between the slip rings 82 and the energy source to control the electrical potential impressed across the electromagnet 54 and hence the current that flows through the magnet 54. The control monitors and responds to several operating conditions of the engine, including engine speed, throttle position, pressure within the manifold 2, speed of impellers 12 and 14, and engine pressure.

The magnetic particles in the gap g between the of two clutch elements 50 and 52 transfer torque from the outer element 52 to the inner element 50, but only when the electromagnet 54 is energized. Moreover, when the electromagnet 54 is energized and the transfer of torque occurs, the velocity of the inner element 50 relative to the outer element 52 depends on the magnitude of the current passing through the magnet 54 which in turn depends on the magnitude of the electrical potential impressed across it. In any event, the electromagnet 54 creates a magnetic field in the gap g, and the strength of that field determines the relative speed between the inner and outer clutch elements 50 and 52.

The driven pulley 20 serves as a drive member for the supercharger A. It encircles the outer element 52 of the magnetic particle clutch 18 and is coupled to the outer element 52 through machine screws 90, so that the pulley 16 and outer element 52 rotate together always at the same angular velocity. The belt 8 passes over the pulley 16 and likewise over the pulley 6 on the crankshaft 4 of the engine (FIG. 2), so that the crankshaft 4 drives the outer element 52 such that a fixed ratio exists between the velocities of the two—but not between the crankshaft 4 and the impellers 12 and 14.

In the operation of an engine equipped with the supercharger A, the supercharger A may be utilized to boost the power delivered by the engine or it may remain inactive, depending on the demands placed upon the engine and the desires of the operator of the vehicle powered by the engine.

Normally, no electrical potential is impressed across the electromagnet 54 of the clutch 18, and the clutch 18 does not transmit any torque. As a consequence, the impellers 12 and 14 remain at rest and the engine is conventionally aspirated. As such, supercharger A consumes virtually no power and thus does not detract from the efficiency of the engine.

However, when driving conditions demand more power than the conventionally aspirated engine can deliver, an electrical potential, transferred through the connector assembly 56, is impressed across the electromagnet 54 of the clutch 16. The magnetic particles in the gap g become magnetized and transfer torque from the outer element 52 of the clutch 18 to the inner element 50, and the impellers 12 and 14 rotate and force air into the manifold 2, so that the pressure of the air in the manifold 2 increases and likewise so does the mass flow of air delivered to the cylinders. The engine produces more power than it would otherwise.

The magnitude of the boost in power need not correlate with engine speed and indeed, the velocity of the impellers 12 and 14 relative to the velocity of the pulley 16 can vary depending on the current in the electromagnet 54. To be sure, the maximum boost is to a measure restricted by engine speed, but at moderate engine speeds, such as those encountered during normal highway driving, the supercharger A may operate relatively slowly or not at all. However, when extra power is required, such as when passing, the supercharger A can be brought into operation almost immediately to provide a high level boost. Similarly, at low engine speeds, the supercharger A may be called upon to increase power, again almost instantly, and this provides greater acceleration.

Should the throttle for the engine equipped with the supercharger A suddenly be released, the engine management system will immediately deenergize the electromagnet 54 of the clutch 16, so that the impellers 12 and 14 are no longer powered. They come to rest, causing the pressure within the manifold to drop. This eliminates the need for a relief valve.

Variations are possible. For example the mechanical coupling between the crankshaft 4 and the clutch 16 of the supercharger A may be a gear train or a sprocket-and-chain drive. The electromagnet 54 of the clutch 16 may be carried by the inner clutch element 50 or it may be located externally of both clutch elements 50 and 52, yet close enough to enable the magnetic field produced by it to pass through the gap g between the clutch elements 50 and 52. A magnetorheological clutch may be substituted for the magnetic particle clutch 16. This type of clutch utilizes a magnetorheological fluid as its torque-transfer substance. To this end, the viscosity of the fluid may be altered with a magnetic filed—the stronger the field greater the viscosity. The clutch includes an electromagnet for producing the magnetic flux that controls the viscosity of the fluid in the clutch. The housing may assume other configurations and may hold impellers of other configurations. For example, the housing and impellers may be those of a Roots-type blower, its vanes being the lobes of such a blower. Likewise, the housing and impeller may be those of a simple centrifugal compressor. Furthermore, the supercharger A may be installed on a compression ignition engine as well as a spark ignition engine. The engine need not be that of an automobile, but may be a marine or aircraft engine or for that matter a stationary engine.

1. A supercharger for an internal combustion engine, said supercharger comprising:
a housing;
an impeller including vanes located in the housing and configured to move and pressurize air;
a rotary drive member; and
a magnetic clutch interposed between the rotary drive member and the impeller, the clutch including a first clutch element that rotates with the impeller and a second clutch element that rotates with the drive member, an electromagnet that produces a magnetic field, and a substance through which torque is transferred between the first and second clutch elements, the substance being responsive to the magnetic field produced by the electromagnet such that the velocity of the first clutch element relative to the second clutch element depends on the strength of the magnetic field, whereby the speed at which the impeller rotates is independent of the speed at which the drive member rotates and is controlled by the clutch.

2. A supercharger according to claim 1 wherein the first and second clutch elements, the impeller, and the drive member rotate about a common axis.

3. A supercharger according to claim 1 wherein the clutch is a magnetic particle clutch.

4. A supercharger according claim 3 wherein the first clutch element has a peripheral surface that is presented away from the axis; wherein the second clutch element has an interior surface that is presented toward the axis and toward the peripheral surface of the first clutch element; there being a gap that exists between the peripheral surface of the first element and the interior surface of the second element; and wherein the substance through which torque is transferred is magnetic particles that are in the gap.

5. A supercharger according to claim 4 wherein the peripheral surface of the first element and the interior surface of the second element are cylindrical and parallel.

6. A supercharger according to claim 3 wherein the electromagnet is carried by one of the clutch elements; and further comprising a connector for connecting the electromagnet with an electrical energy source that remains stationary while clutch elements rotate.

7. A supercharger according to claim 6 wherein the connector includes slip rings and brushes that contact the slip rings.

8. A supercharger according to claim 1 wherein the clutch is a magnetorheological clutch and the substance through which torque is transferred is a magnetorheological fluid.

9. In combination with the manifold of an internal combustion engine, a supercharger connected to the manifold for boosting the pressure of air within the manifold, said supercharger comprising:
a housing enclosing a chamber that communications with the manifold;
a rotary driven member within the chamber for drawing air into the chamber and discharging it into the manifold;
a rotary drive member powered by the engine; and
a magnetic clutch interposed between the rotary drive and driven members and including a first clutch element connected to the driven member, a second clutch element connected to the drive member, a torque-transferring substance located between the first and second clutch elements and being responsive to a magnetic field in the sense that the amount of torque transferred by the substance varies with the strength of the field, and an electromagnet for creating a magnetic field within which the torque-transferring substance lies.

10. The combination according to claim 9 wherein the clutch is a magnetic particle clutch in which the torque-transferring substance is magnetic particles.

11. The combination according to claim 10 wherein the first clutch element has a peripheral surface and the second clutch element has an interior surface located close to the peripheral surface of the first element so that a gap exists between the two surfaces; and wherein the magnetic particles are in the gap.

12. The combination according to claim 11 wherein the electromagnet is carried by one of the clutch elements.

13. A process for controlling the power delivered by an internal combustion engine having a manifold; and a crankshaft from which power is delivered from the engine, said process comprising:
installing a supercharger on the manifold to pressurize the manifold;
connecting the supercharger to the crankshaft through a clutch having a first clutch element that is driven by the crankshaft at a speed that correlates directly with the speed of the crankshaft and a second clutch element that is coupled to the supercharger and rotates at a speed that correlates directly with the speed of the supercharger, the clutch also including an electromagnet and a torque transferring substance between the first and second clutch elements, with the torque transferring substance being responsive to the magnetic field produced by the electromagnet in the sense that the amount of torque transferred is dependent on the strength of the field produced by the magnet; and
varying the strength of the field produced by the magnet to accommodate demands placed on the engine.
